(19) United States
(12) Patent Application Publication
(10) Pub. No.: US 2005/0264490 A1
(43) Pub. Date: Dec. 1, 2005

(54) Plasma display panel driving device and method

(76) Inventor: Sang-Chul Kim, Suwon-si (KR)

Correspondence Address: McGuireWoods LLP, Suite 1800, 1750 Tysons Boulevard, McLean, VA, 22102, US

(21) Appl. No.: 11/134,276

(22) Filed: May 23, 2005

(30) Foreign Application Priority Data
May 25, 2004 (KR) 10-2004-0037274

(51) Int. Cl. G09G 3/28

(52) U.S. Cl. 345/66

(57) ABSTRACT

In a plasma display panel, sustain discharge pulses having a first voltage and a second voltage, which is a negative voltage of the first voltage, may be applied to a scan electrode when a sustain electrode is biased with the ground voltage during a sustain period. The second voltage is generated without providing an additional power source but rather by a sustain discharge supply circuit, supplied with the first voltage, that repeatedly performs switching operations to generate the second voltage.

### CROSS-REFERENCE TO RELATED APPLICATION

This application claims priority to and the benefit of Korean Patent Application No. 10-2004-0037274, filed on May 25, 2004, which is hereby incorporated by reference.

### BACKGROUND OF THE INVENTION

1. Field of the Invention

The present invention relates to a device and method for driving a plasma display panel (PDP).

2. Discussion of the Related Art

A plasma display device, which includes a PDP, is a flat display that uses plasma generated via a gas discharge process to display characters or images. Depending on its size, the PDP may have up to millions of pixels arranged in a matrix format. PDPs are categorized into direct current (DC) PDPs and alternating current (AC) PDPs, depending on the supplied driving voltage waveforms and discharge cell structures.

Since DC PDPs have electrodes exposed in the discharge space, they allow a current to flow in the discharge space while the voltage is supplied, and thus require resistors for current restriction. In contrast, because AC PDPs have electrodes covered by a dielectric layer, capacitances are naturally formed that restrict the current and the electrodes are protected from ion shocks during discharging. Accordingly, AC PDPs have a longer lifespan than DC PDPs.

As shown in FIG. 1, the PDP includes opposing glass substrates 1 and 6 facing each other with a discharge space 11 disposed therebetween. A plurality of scan electrodes 4 and sustain electrodes 5 are arranged in parallel pairs on front glass substrate 1 and extend along a first direction. Scan electrodes 4 and sustain electrodes 5 are covered by a dielectric layer 2 and a protective film 3. A plurality of address electrodes 8 are formed on back glass substrate 6 and extend along a second direction that is substantially perpendicular to the first direction. Address electrodes 8 are covered by an insulator layer 7 having barrier ribs 9 formed thereon, which are between address electrodes 8. Phosphors 10 are disposed on a surface of insulator layer 7 facing front substrate 1 and on both sides of barrier ribs 9. A discharge cell 12 is formed within discharge space 11 at an intersection of an address electrode 8 and a pair of a scan and sustain electrodes 4 and 5.

As shown in FIG. 2, a conventional plasma display includes a PDP 10, a chassis base 20, a front case 30, and a rear case 40. Chassis base 20 is fastened to the PDP 10 on its back side opposite the front image display side. Front case 30 and rear case 40 are arranged on the front side of PDP 10 and the rear side of chassis base 20, respectively, and are combined to provide a plasma display.

Referring to FIG. 3, PDP 10 includes a plurality of address electrodes A₁ to Aₘ arranged in columns along the second direction, and a plurality of scan electrodes Y₁ to Yₙ and sustain electrodes X₁ to Xₙ grouped in pairs and arranged in rows along the first direction. Sustain electrodes X₁ to Xₙ have corresponding scan electrodes Y₁ to Yₙ. Terminals of the sustain electrodes X₁ to Xₙ are connected in common. PDP 10 includes an insulation substrate on which sustain electrodes and scan electrodes X₁ to Xₙ and Y₁ to Yₙ are provided, and another insulation substrate on which the address electrodes A₁ to Aₘ are provided. The two insulation substrates face each other with a discharge space therebetween so that the pairs of scan and sustain electrodes may cross the address electrodes to form a discharge cell 12.

A frame of an AC PDP includes a plurality of subfields, and a subfield may include a reset period, an address period, and a sustain period.

In the reset period, the respective discharge cells are reset in order to perform fluent address operations. In the address period, discharge cells are selected to be turned on and wall charges accumulate on the turned on cells (i.e., addressed cells). In the sustain period, alternately applying sustain pulses to sustain and scan electrodes generates a sustain discharge in the addressed cells, thereby displaying an image.

During the sustain period, a sustain discharge voltage of Vₛ is alternately applied to the scan electrode and the sustain electrode so that the voltage difference between the scan electrode and the sustain electrode may be the sustain discharge voltage of Vₛ in the case of applying sustain pulses in the sustain period. A reference voltage of 0V is applied to the sustain electrode when the sustain discharge voltage of Vₛ is applied to the scan electrode.

Now referring to FIG. 4A, the reference voltage may be applied to the sustain electrode, and ±Vₛ may be alternately applied to the scan electrode during the sustain period in a conventional PDP driving method. By driving the PDP in this manner, the voltage difference between the scan electrode and the sustain electrode is at Vₛ. In an alternative conventional method for driving a PDP, as shown in FIG. 4B, sustain discharge pulses of ± 1/2Vₛ are alternately applied to the scan electrode and the sustain electrode, respectively, and the voltage difference between the scan electrode and the sustain electrode is maintained at the sustain discharge voltage of Vₛ.

In general, because the sustain discharge is generated by the voltage difference between the scan and sustain electrodes, so long as this voltage difference is maintained at Vₛ, the sustain discharge operation will be sufficient for displaying images, even when varying sustain pulses are applied to the scan electrode and the sustain electrode.

However, an additional power source may be needed for supplying the sustain discharge voltages of −Vₛ and − 1/2Vₛ, thereby increasing production costs. Therefore, the cost of providing a PDP may be higher when attempting to supply the sustain discharge voltages of ±Vₛ and ± 1/2Vₛ to the scan electrode and the sustain electrode.

### SUMMARY OF THE INVENTION

The present invention provides a PDP driver for supplying sustain discharge voltages to scan electrodes and sustain electrodes without adding a power source for supplying varying sustain discharge voltages.

The present invention discloses a PDP driver for alternately applying sustain discharge pulses including a first voltage and a second voltage to a first electrode of a PDP having a plurality of first electrodes and a plurality of second electrodes. The PDP driver includes a first switch and a second switch coupled in series between a first power for supplying the first voltage and the ground; a first capacitor having a first terminal coupled to a node of the first switch and the second switch; a first diode coupled between a second terminal of the first capacitor and the ground to permit a current path in the direction from the second terminal of the first capacitor to the ground; a second capacitor having a grounded first terminal; and a second diode coupled between a second terminal of the second capacitor and the second terminal of the first capacitor to permit a current path in the direction from the second capacitor to the first capacitor, the second terminal of the second capacitor supplying the second voltage.

The present invention also discloses a method for driving a PDP including charging a first voltage in a first capacitor coupled to a power source for supplying the first voltage; providing a current path between the first capacitor and a second capacitor, generating a second voltage through the second capacitor by repeating the steps of charging the first voltage and providing a current path for a predetermined number of times; and alternately applying the first voltage and the second voltage to a first electrode of a PDP having a plurality of first electrodes and a plurality of second electrodes.

### BRIEF DESCRIPTION OF THE DRAWINGS

FIG. 1 shows a perspective view of an AC PDP.

FIG. 2 shows a perspective view of a conventional plasma display.

FIG. 3 shows a schematic diagram of a conventional PDP.

FIG. 4A and FIG. 4B show conventional PDP driving waveform diagrams.

FIG. 5 shows a sustain discharge voltage supply circuit according to an embodiment of the present invention.

FIG. 6 shows a switch operation timing diagram for a sustain discharge voltage supply circuit.

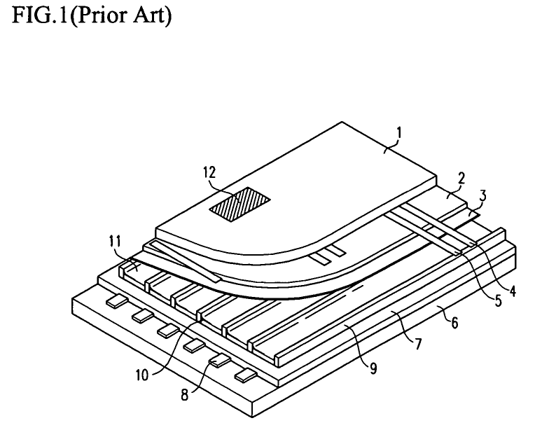

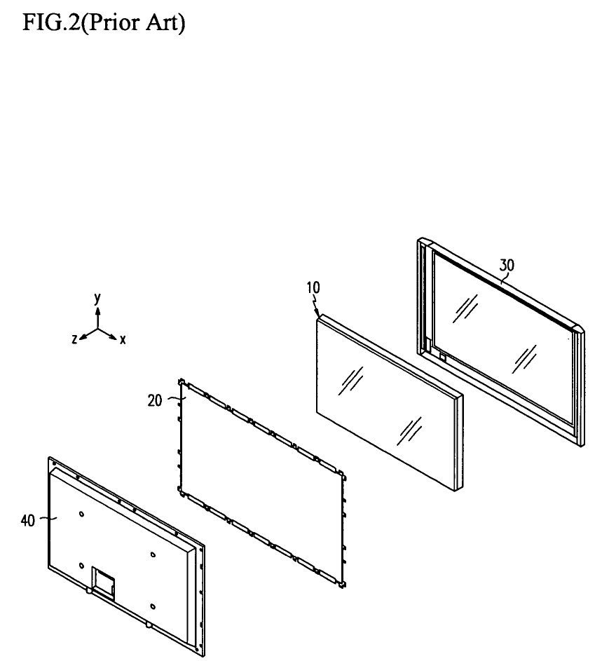

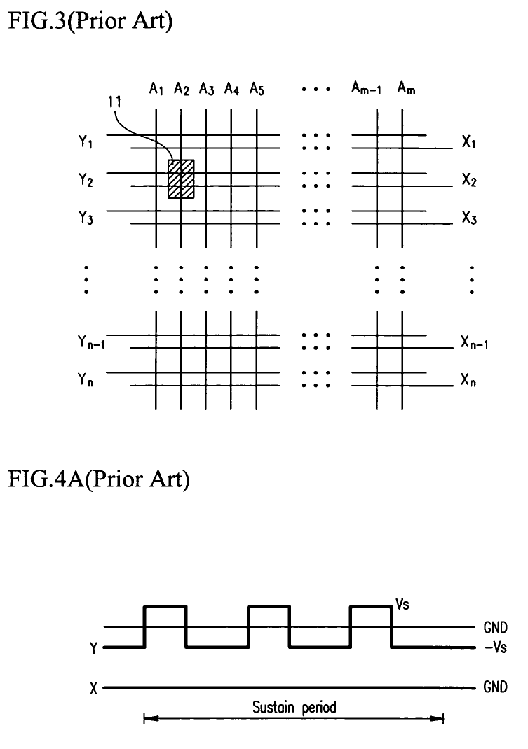

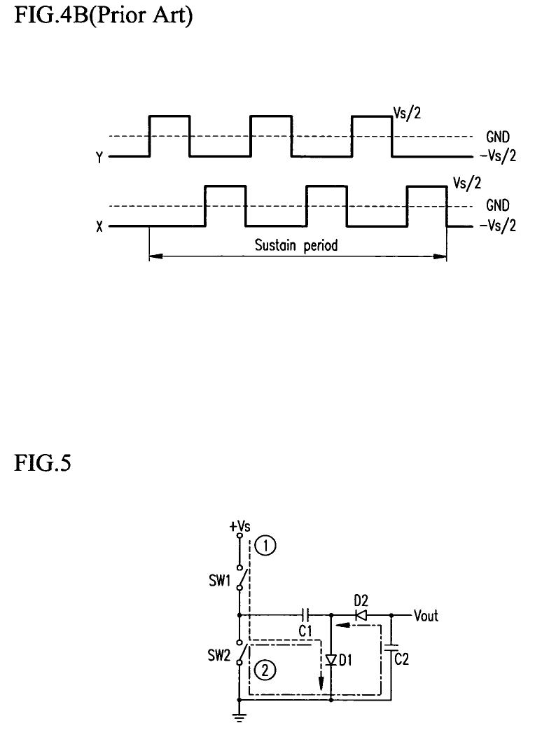

### DETAILED DESCRIPTION

In the following detailed description, embodiments of the present invention are shown and described by way of illustration. As those skilled in the art would recognize, the described embodiments may be modified in various ways, all without departing from the spirit or scope of the present invention. Accordingly, the drawings and description are to be regarded as illustrative in nature, rather than restrictive.

FIG. 5 shows a sustain discharge voltage supply circuit according to an embodiment of the present invention. As shown, the sustain discharge voltage supply circuit includes a power source supplying the sustain discharge voltage Vₛ, switches SW1 and SW2, capacitors C1 and C2, and diodes D1 and D2.

Switches SW1 and SW2 are coupled in series between the power source and the ground. Capacitor C1 has a first terminal coupled to a node of switches SW1 and SW2, and diode D1 is coupled between a second terminal of capacitor C1 and the ground to thus form a current path in the direction towards the ground. Capacitor C2 has a grounded first terminal, and diode D2 is coupled between the second terminal of the capacitor C2 and the second terminal of capacitor C1 to thus form a current path in the direction towards capacitor C1. A voltage of Vₒᵤₜ is coupled to a node of the anode of diode D2 and the second terminal of capacitor C2.

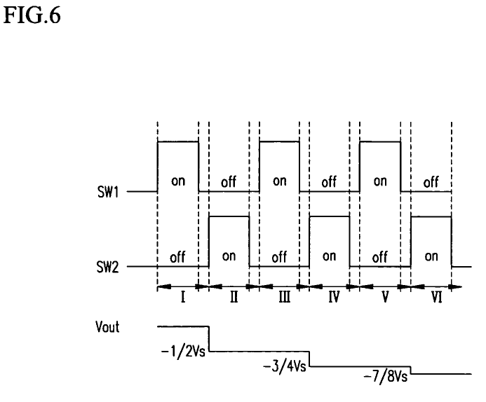

Referring to FIG. 6, a process for repeating on/off operations of the switches SW1 and SW2 to generate the voltage of −Vₛ will now be described. In period I, switch SW1 is turned on and switch SW2 is turned off. Capacitor C1 is charged with the sustain discharge voltage of +Vs when switch SW1 is turned on, and the current path in this instance is illustrated by \mathring{1}(C1-D1).

In period II, switch SW1 is turned off and switch SW2 is turned on. The current path when switch SW2 is turned on is illustrated by \mathring{2}(C1-SW2-C2-D2-C1). When the capacitance of capacitor C1 is controlled to correspond with the capacitance of capacitor C2, the sustain discharge voltage +Vₛ of capacitor C1 during period I is discharged to reach an equilibrium state, capacitors C1 and C2 are then charged with a sustain discharge voltage of 1/2Vₛ, and the output voltage of Vₒᵤₜ becomes − 1/2Vₛ.

In period III, switch SW1 is turned on and switch SW2 is turned off. Capacitor C1 is charged with the sustain discharge voltage of +Vₛ, just as in period I, when switch SW1 is turned on, and capacitor C2 maintains the previous state and the output voltage of Vₒᵤₜ is maintained at the voltage of − 1/2Vₛ because switch SW2 is turned off.

In period IV, switch SW1 is turned off and switch SW2 is turned on, and current flows in the path of \mathring{2}, as in period II. The difference between the voltage of Vₛ charged in capacitor C1 and the voltage of 1/2Vₛ charged in capacitor C2 is discharged, and capacitor C2 is charged with the voltage of 1/4Vₛ. Thus, capacitor C2 is charged with the voltage of 3/4Vₛ( 1/2Vₛ+ 1/4Vₛ), and the output voltage of Vₒᵤₜ becomes − 3/4Vₛ.

In period V, switch SW1 is turned on and switch SW2 is turned off. Capacitor C1 is charged with +Vₛ, in the manner as period I, and capacitor C2 maintains its previous state and the output voltage of Vₒᵤₜ is maintained at the voltage of − 3/4Vₛ.

In period VI, switch SW1 is turned off and switch SW2 is turned on, and the current flows in the same manner as period II. The difference voltage of 1/4Vₛ between the voltage of Vs charged in the capacitor C1 and the voltage of 3/4Vₛ charged in the capacitor C2 is discharged, and the capacitor C2 is charged with the voltage of 1/8Vs. Therefore, the capacitor C2 is charged with the voltage of 7/8Vs( 3/4Vₛ+ 1/8Vₛ), and the output voltage of Vₒᵤₜ becomes − 7/8Vₛ.

The output voltage of Vₒᵤₜ may eventually reach approximately −Vₛ when the switches SW1 and SW2 are repeatedly turned on and off for a predetermined number of times.

The process for generating a sustain discharge voltage of − 1/2Vₛ is performed in a similar manner as the above-described process. That is, a voltage of − 1/2Vₛ is generated by supplying a voltage of 1/2Vₛ to the sustain discharge supply circuit and repeatedly turning on/off the switches for a predetermined number of times to attain a desired Vₒᵤₜ.

When the power is turned on, the switches of the sustain discharge supply circuit are repeatedly turned on and off in the reset period, the address period, and the sustain period of the respective subfields.

Therefore, a less expensive PDP is realized by the present invention because an additional power source for supplying a negative sustain discharge voltage may not be needed.

It will be apparent to those skilled in the art that various modifications and variation can be made to the disclosed embodiments without departing from the spirit or scope of the invention. Thus, it is intended that the present invention cover the modifications and variations of the disclosed embodiments that come within the scope of the appended claims and their equivalents.

1. A plasma display panel driver for alternately applying sustain discharge pulses including a first voltage and a second voltage to a first electrode of a plasma display panel having a plurality of first electrodes and a plurality of second electrodes, the plasma display panel driver comprising:
a first switch and a second switch coupled in series between a first power for supplying the first voltage and a ground;
a first capacitor having a first terminal coupled to a node of the first switch and the second switch;
a first diode coupled between a second terminal of the first capacitor and the ground to permit a current path in a direction from the second terminal of the first capacitor to the ground;
a second capacitor having a grounded first terminal; and
a second diode coupled between a second terminal of the second capacitor and the second terminal of the first capacitor to permit a current path in a direction from the second capacitor to the first capacitor, the second terminal of the second capacitor supplying the second voltage

2. The plasma display panel driver of claim 1, wherein the second voltage is a negative of the first voltage.

3. The plasma display panel driver of claim 1, wherein a ground voltage is applied to the second electrode in a sustain period.

4. The plasma display panel driver of claim 1, wherein the first electrode is coupled to the second terminal of the second capacitor.

5. The plasma display panel driver of claim 1, wherein pulses alternately having the first voltage and the second voltage are applied to the second electrode in a sustain period such that a voltage differential between the first electrode and the second electrode is sufficient to provide the sustain discharge.

6. The plasma display panel driver of claim 5, wherein the second voltage is a negative of the first voltage.

7. The plasma display panel driver of claim 1, wherein the first voltage is charged in the first capacitor by a switching operation of the first switch.

8. The plasma display panel driver of claim 3, wherein the first voltage is charged in the first capacitor by a switching operation of the first switch.

9. The plasma display panel driver of claim 4, wherein the first voltage is charged in the first capacitor by a switching operation of the first switch.

10. The plasma display panel driver of claim 5, wherein the first voltage is charged in the first capacitor by a switching operation of the first switch.

11. The plasma display panel driver of claim 1, wherein the second voltage is charged in the second capacitor by a switching operation of the second switch.

12. The plasma display panel driver of claim 3, wherein the second voltage is charged in the second capacitor by a switching operation of the second switch.

13. The plasma display panel driver of claim 4, wherein the second voltage is charged in the second capacitor by a switching operation of the second switch.

14. The plasma display panel driver of claim 5, wherein the second voltage is charged in the second capacitor by a switching operation of the second switch.

15. The plasma display panel driver of claim 1, wherein the first switch is turned on when the second switch is turned off and the second switch is turned on when the first switch is turned off.

16. The plasma display panel driver of claim 1, wherein the first voltage corresponds to either approximately a sustain discharge voltage or approximately half the sustain discharge voltage.

17. A method for driving a plasma display panel, comprising:
charging a first voltage in a first capacitor coupled to a power source for supplying the first voltage; and
providing a current path between the first capacitor and a second capacitor;
generating a second voltage through the second capacitor by repeating the steps of charging the first voltage and providing the current path for a predetermined number of times; and
alternately applying the first voltage and the second voltage to a first electrode of a plasma display panel having a plurality of first electrodes and a plurality of second electrodes.

18. The plasma display panel driving method of claim 17, wherein a first terminal of the second capacitor is grounded, and the second voltage is supplied through a second terminal of the second capacitor.

19. The plasma display panel driving method of claim 17, wherein the second voltage is a negative of the first voltage.

20. The plasma display panel driving method of claim 17, further comprising:
applying a ground voltage to a second electrode of the plurality of second electrodes.
